(19) United States
(12) Patent Application Publication
(10) Pub. No.: US 2014/0204472 A1
(43) Pub. Date: Jul. 24, 2014

(54) OPTICAL DEVICE

(71) Applicant: Jos Dingjan, Royston (GB)

(72) Inventor: Jos Dingjan, Royston (GB)

(73) Assignee: THE TECHNOLOGY PARTNERSHIP PLC, Royston, Hertfordshire (GB)

(21) Appl. No.: 14/128,774

(22) PCT Filed: Jun. 28, 2012
(86) PCT No.: PCT/GB2012/051509

§ 371 Date: Apr. 4, 2014

(30) Foreign Application Priority Data
Jun. 28, 2011 (GB) 1110954.3

(51) Int. Cl. G02B 7/04

(52) U.S. Cl. CPC G02B 7/04
USPC 359/721

(57) ABSTRACT

An optical device (20) that comprises at least two refractive optical elements (1, 2) arranged along an optical axis (OA) of the device, each refractive optical element having a surface profile. The device has an optical aperture common to the at least two refractive optical elements and wherein at least one refractive optical element is arranged to rotate relative to another refractive optical element around a rotation axis which intersects the aperture of the device. The device has a plurality of configurations, each configuration having a predetermined optical property, such as the focal length, over at least a first region of the aperture; the configurations being selected by rotating the at least one refractive optical element arranged to rotate. The total area of the first regions divided by the total area of the aperture is a function of the surface profiles of the at least two refractive optical elements.

The present invention relates to an optical device and in particular to an optical lens with variable optical properties.

There have been many attempts to produce lenses with variable optical properties, such as variable focus lenses. Existing devices known as “Alvarez lenses” comprise optical elements with suitably designed surface shapes such that the resulting lens power can be varied by moving the optical elements relative to each other. One can distinguish between different types of Alvarez lenses based on the nature of the relative movement of the lens elements.

Classic Alvarez lenses comprise two optical elements which translate perpendicular to the optical axis and parallel or generally parallel to each other. This can be a pure translation, or a motion close to a pure translation, generated by a rotation of the optical elements around an axis that is perpendicular to the optical axis and placed in front of or behind the optical elements, as described for example in U.S. Pat. No. 3,305,294 and U.S. Pat. No. 3,507,565. A more recent variation of this type of Alvarez lens employs Fresnel-type methods to reduce the thickness of the individual elements and is described in U.S. Pat. No. 7,841,715.

Another type of Alvarez lenses comprises optical elements arranged to rotate around an axis of rotation that is decentred with respect to the optical axis, and that does not intersect the optical aperture, as described in U.S. Pat. No. 4,650,292.

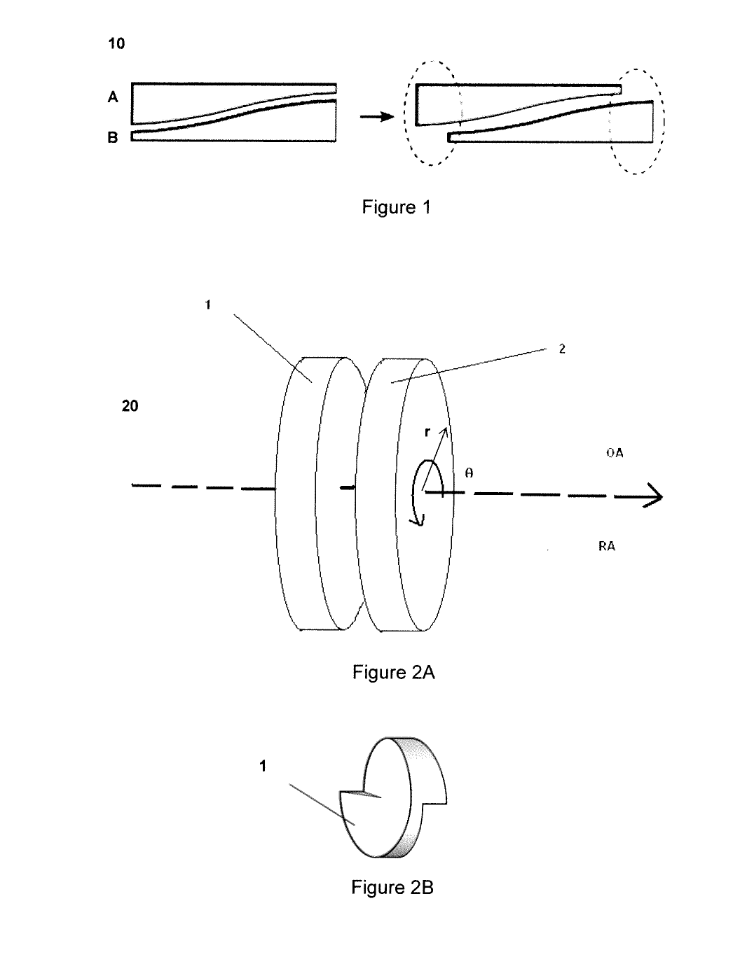

Both of the above types of variable lenses, as well as combinations of such devices, have a disadvantage in that parts of the optical elements extend outside the optical aperture in at least some of their possible states. Typically, these are regions at the edges where the optical elements do not overlap because they have been moved relative to each other. An example of such lenses is illustrated in FIG. 1. The lens of FIG. 1 comprises two optical elements (A and B) moveable relative to each other. The translation of the optical elements relative to each other necessarily leads to non-overlapping regions, indicated in FIG. 1 by dashed ellipses.

Accordingly, there is a need for a variable lens which avoids non-overlapping regions of the optical elements and therefore uses the full optical aperture of the lens. In particular, there is a need for a refractive lens with variable focus, which overcomes the problems of existing devices described above.

According to the present invention, there is provided an optical device comprising at least two refractive optical elements arranged along an optical axis of the device, each refractive optical element having a surface profile,

wherein the device has an optical aperture common to the at least two refractive optical elements and wherein at least one refractive optical element is arranged to rotate relative to another optical element around a rotation axis which intersects the aperture of the device,

wherein the device has a plurality of configurations, each configuration having a predetermined optical property over at least a first region of the aperture; the configurations being selected by rotating the at least one refractive optical element arranged to rotate; and

wherein the total area of the first regions divided by the total area of the aperture is a function of the surface profiles of the at least two refractive optical elements.

According to the present invention there is also provided a method of selecting a configuration from a plurality of configurations of an optical device, the method comprising the steps of:

directing light through an optical aperture common to at least two refractive optical elements arranged along an optical axis, wherein each refractive optical element has a surface profile; and

rotating at least one refractive optical element relative to another refractive optical element around a rotation axis which intersects the aperture,

wherein each configuration has a predetermined optical property over at least a first region of the aperture; and

wherein the total area of the first regions divided by the total area of the aperture is a function of the surface profiles of the at least two refractive optical elements.

In contrast with existing types of Alvarez lenses, the device in accordance with the present invention comprises refractive optical elements arranged to rotate around a rotation axis which intersects the aperture of the lens and is not perpendicular to the optical axis. In preferred configurations, the rotation axis is parallel to but displaced from or coincides with the optical axis. Advantageously, this avoids non-overlapping regions of the refractive optical elements, resulting into a more compact device with higher efficiency.

The desired behaviour of the device is to have a single optical property, such as optical power for example, over the entire optical aperture, for each of the different configurations of the device, or at least a significant fraction of them. It will be understood by the person skilled in the art that, mathematically, this is not possible for more than one configuration, without making significant approximations. In order to overcome this mathematical hurdle and achieve the desired behaviour, the present invention sub-divides the optical aperture into first regions (regions 1) having the desired predetermined optical property (e.g. optical power). Hereafter, such regions are also called “good” regions or areas, and the terms may be used interchangeably. Areas with a different optical property (e.g. a different optical power or even very different optical properties such as aberrations) are referred to as second regions (regions 2). Hereafter, such regions are also called “bad” regions or areas, and the terms may be used) interchangeably.

It will be appreciated that the principle can be extended beyond changes in optical power to switching other optical properties or optical characteristics, including aberrations, such as spherical aberration, higher order spherical aberration, and other optical properties that have rotation symmetry.

It will also be appreciated that it is possible to have more than two types of regions (“good” and “bad”) with distinct optical properties. Accordingly, the device may comprise, third or fourth regions (regions 3, 4 etc.) and so on, each of these types having properties distinct from the predetermined properties of the first regions. Depending on the desired behaviour of the lens, such regions may be labelled or grouped together (regions 2, 3, 4 etc) as “bad” regions. Alternatively, it is possible to classify some or all regions distinct from regions 1 as “good-but different” regions. For example, as will be explained below, a device may be designed to have two or more focal lengths, one for each of the first and second (etc.) regions.

According to the present invention, the area-fraction of the aperture that is “good” or “bad” varies with the configuration of the lens and depends on the design of the individual optical elements, i.e. the design of their surface profiles. By ‘profile’ it is meant the thickness of an element in a direction along the optical axis. ‘Surface profile’ refers to the combination of surface shapes of the surfaces of an element, wherein the element may have one or two surfaces of this type (for example one surface on each side of the element, if the element has two sides). The obtained (“good” or “bad”) regions are a property of the element profile and therefore are determined by the combination of the at least one surface profile of the element. Accordingly, by suitably shaping the surfaces of an element, one can re-shape the thickness profile and therefore the obtained regions. By ‘area-fraction’, it is meant the total area of the “good” (or “bad”) areas divided by the total area of the optical aperture.

More specifically, the ratio of the “good”/“bad” areas is a function of the profiles and the relative orientation of the elements (selecting a configuration of the device). It will be understood that the profiles of the individual refractive optical elements are interdependent through the requirement that, in combination, they provide certain optical properties over at least part of the aperture. Advantageously, therefore, the size, shape and distribution of the “bad” areas can be extensively engineered to obtain optimum performance as required by a particular application of the device.

A masking element may be arranged adjacent to the at least two refractive elements such that the second regions are opaque to light transmitted, in use, through the aperture. The masking element may be fixed and therefore only exactly matched to the shape of the “bad” areas for one or a few configurations. Alternatively, the masking element may be variable, such as for example, a pixellated LCD shutter.

Alternatively, instead of a masking element, the device may comprise a light absorber, the at least two refractive elements being arranged such that light transmitted through the aperture is directed to the light absorber.

Advantageously, therefore, the “bad” areas of the aperture may be masked out or redirected into an absorber in order to allow only the “good” areas to be light transmitting. In alternative devices, as mentioned above, the surface profiles of the refractive optical elements may be designed such that a second (“bad”) region has a property which is distinct from that of a first (“good”) region, but is still a useful region. For example, a device may be designed to have two or more variable focal lengths, one for each of the first and second regions.

The amounts by which the optical elements are rotated may be distinct but not necessarily independent. Alternatively, rotating the at least one refractive optical element comprises continuously rotating at least one refractive optical element. Alternatively, the rotation is performed in discrete amounts.

In preferred embodiments, the area of the aperture is a disk (i.e. the aperture is a circular aperture with the optical axis running through the centre of the disk). In such embodiments, the shapes of the “bad” areas may be sectors or wedges, for example, and the “good” areas are therefore the complementary part of the disk. A first possible modification of the shape of the “bad” areas is to divide (‘split up’) a wedge into two or more smaller wedges, of the same or different sizes, such that the total area of the smaller wedges equals that of the initial wedge. According to a second possible modification, the “bad” areas may be reshaped by displacing part of the wedges around the rotation axis, either in discrete steps or continuously. By combining the two possible modifications described above, a single wedge may be advantageously reshaped, for example, as two tapering spirals that get wider with increasing radius (i.e. in the outward direction). Such rapidly wrapping spiral regions can advantageously provide a more orientation-independent modulation transfer function (MTF). Alternatively, the regions may be reshaped to provide a MTF optimised for a particular task, such as being maximized for one orientation and minimized for a second orientation.

By suitably designing the two or more optical elements of the device, the “bad” areas may be a single contiguous region, or may be subdivided azimuthally into two or more sub-regions. The sub-regions may or may not have the same angular width and may be distributed uniformly or non-uniformly throughout the aperture. Additionally, the “bad” areas may be subdivided radially into two or more disconnected regions, where these regions may or may not have the same radial width. Radial and azimuthal subdivision may also be combined and mixed, so that the number of “bad” areas at each radius need not be the same.

In one embodiment, the area of a second region divided by the area of a first region may be dependent on the distance of the second region from the axis of rotation. Accordingly, it is possible to reduce the size of the “bad” areas in part of the aperture for certain configurations, at the expense of increasing the size of those same “bad” areas for certain other configurations. This enables yet further tailoring of the device to particular applications.

It will be appreciated that the same methods may be used for devices where the axis of rotation of the optical elements does not coincide with the optical axis (but nevertheless intersects the optical aperture). For example, the axis of rotation may be displaced laterally while remaining parallel with the optical axis, may be tilted relative to the optical axis or may be a combination of these two possible modifications.

An example of the present invention will now be described with reference to the accompanying drawings in which:

FIG. 1 shows an “Alvarez lens” known in the art with optical elements sliding perpendicular to the optical axis;

FIG. 2A shows a device in accordance with the present invention;

FIGS. 2B schematically show a further possible shapes of an optical element;

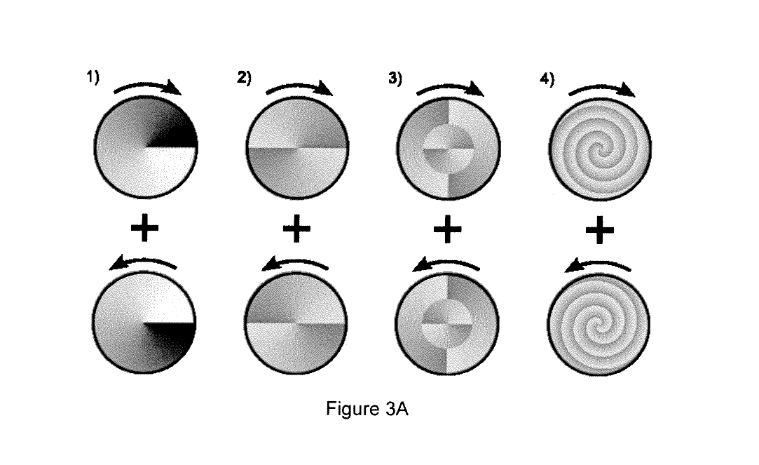

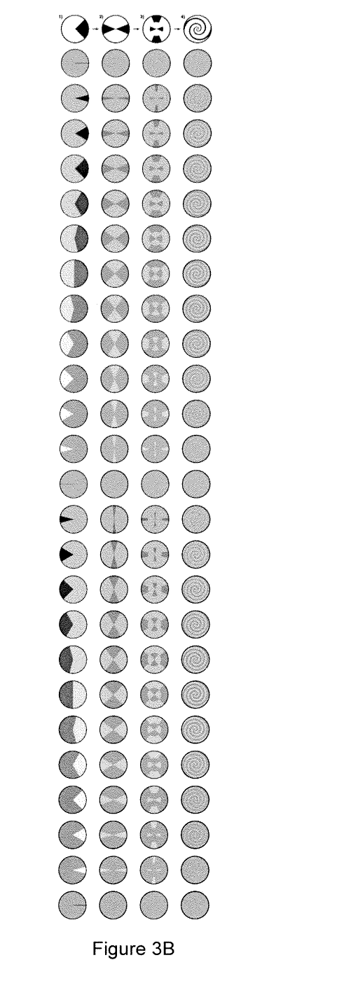

FIG. 3A illustrates elements of four devices according to the present invention;

FIG. 3B illustrates 25 different configurations of the four devices represented in FIG. 3A;

FIG. 3C illustrates the elements shown in FIGS. 3A and 3B rotated so that surface discontinuities do not coincide when the elements are superimposed;

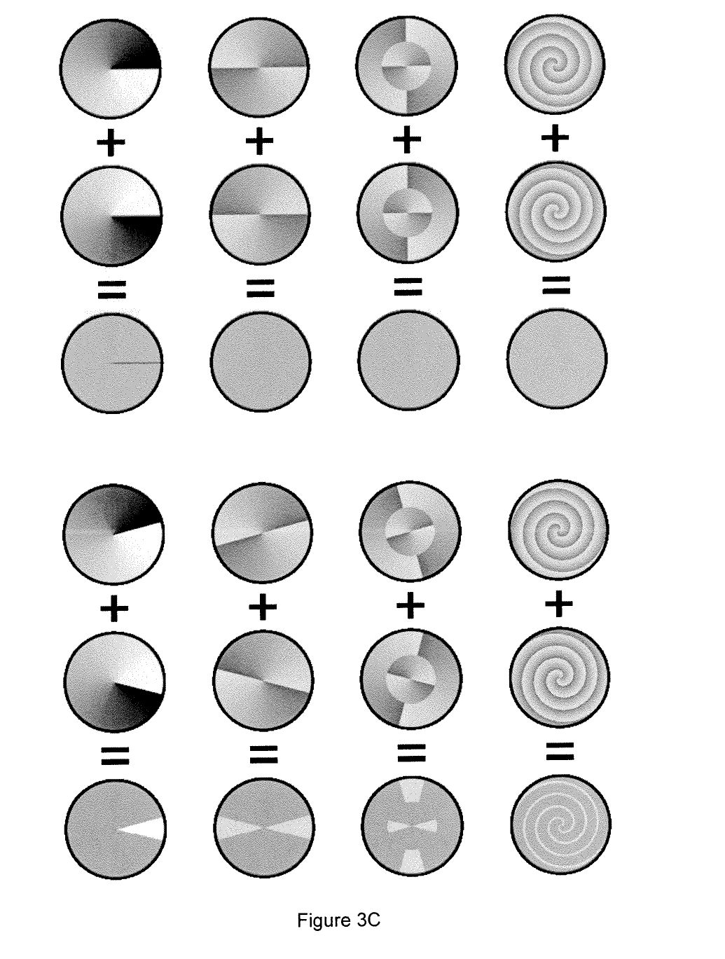

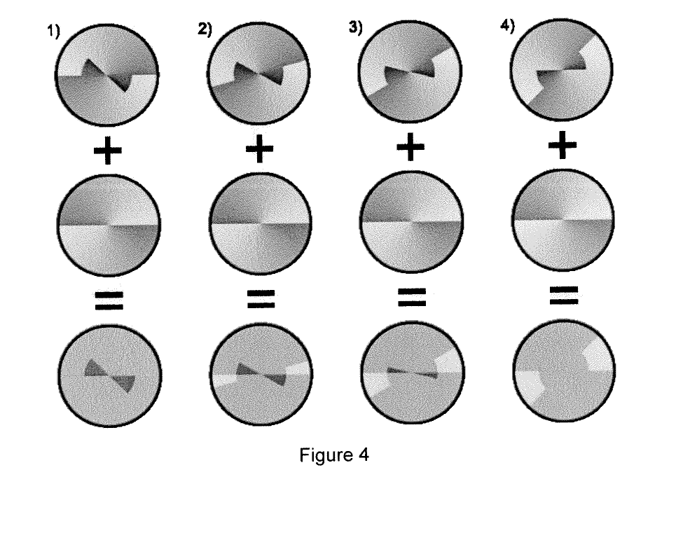

FIG. 4 illustrates another device according to the present invention;

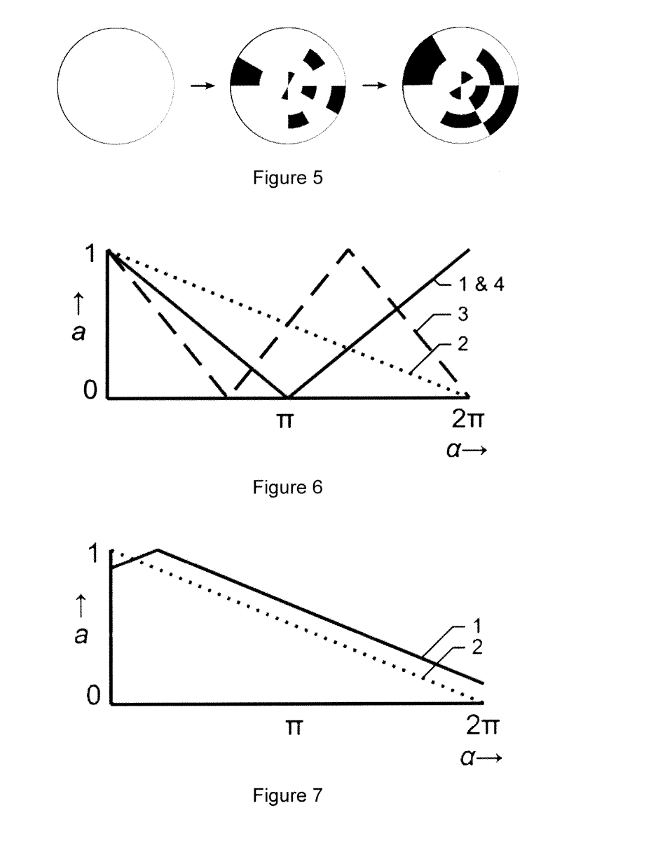

FIG. 5 illustrates another device according to the present invention in three configurations, having different subdivisions (annular regions) and orientations of “bad” areas at different radii;

FIG. 6 is a graph showing the ratio of “good” areas to the total area of the aperture for each of the annular regions of FIG. 5 as a function of relative rotation;

FIG. 7 is a graph showing the ratio of the “good” areas to the area of the annular region for the first two annular regions in FIG. 4 as a function of relative rotation; and

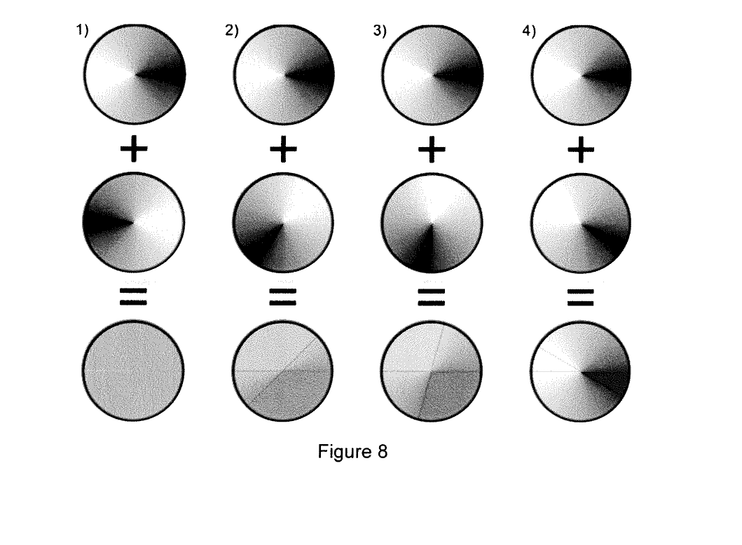

FIG. 8 illustrates further devices in accordance with the present invention.

FIG. 2A schematically represents an exemplary device 20 in accordance with the present invention. The device 20 has two refractive optical elements 1, 2 positioned along a common optical axis OA and spaced from each other along the optical axis by a relatively small distance. The transverse dimensions of the individual elements can range from a millimetre or smaller to a metre or larger. Their thickness (in a direction along the optical axis) will vary accordingly, ranging from a fraction of a millimetre or smaller to several centimetres or larger. The typical distance between elements can range from less than a millimetre to several centimetres or more. It will be appreciated that other devices may have three or more refractive optical elements arranged along a common optical axis OA.

The optical elements 1, 2 illustrated in FIG. 2A are in the shape of a disk. Accordingly, the optical elements 1, 2 have a common optical aperture in the shape of a disk (the aperture is a circular aperture with the optical axis running through the centre of the disk). It will be appreciated, however, that the optical elements and common optical aperture may have other shapes, such as squares, rectangles, triangles, or more complicated or irregular shapes. Furthermore, the elements may extend beyond the optical aperture, and the shape of the optical aperture may differ from the shape of the elements.

At least one of the optical elements 1, 2 may rotate around a rotation axis RA (in a direction indicated by the arrow), such that the optical elements rotate relative to each other. In FIG. 2, the rotation axis RA of the device 20 coincides with the optical axis OA. Other devices may have an axis of rotation RA which does not coincide with the optical axis OA but nevertheless intersects their common optical aperture (wherein the rotation axis RA is not perpendicular to the optical axis OA). For example, the axis of rotation RA may be displaced laterally while remaining parallel with the optical axis OA, may be tilted relative to the optical axis OA or may be a combination of these two possible modifications.

The amounts (angles) by which the refractive optical elements 1, 2 are rotated relative to each other may be distinct but not necessarily independent. It is possible that all optical elements of the device rotate, or all but one. The relative rotation may be in discrete amounts or continuous.

A particular combination of rotation angles for the optical elements defines a configuration (or state) of the device 20, wherein, in one configuration, the device has an optical property, such as a focal length. Accordingly, the possible configurations of a device may be discrete or continuous.

For clarity, FIG. 2A schematically shows optical elements with relatively constant thickness across the optical aperture. Other element profiles shown schematically in FIG. 2B may have discontinuities in the thickness profile. However, the surfaces of the refractive optical elements 1, 2 according to the invention are shaped such that each optical element has a suitable profile (the details of which are not visible in FIG. 2, but will be described in detail below). The profiles are achieved by methods known in the art, such as diamond machining, injection moulding or casting of the optical elements. CNC machining, hand-polishing, moulding onto element pre-forms, etc.

The desired behaviour of the device 20 is to have a single optical property, such as optical power, over the entire optical aperture, for each of the different configurations, or at least a significant fraction of them. Accordingly, the surface (which may be a combination of two surfaces for example) of the elements is shaped such that the optical aperture is sub-divided into first regions (regions 1) having the desired predetermined optical property (e.g. optical power). Such regions are also called “good” regions or areas. An area with a different optical property (e.g. a different optical power or even very different optical properties such as aberrations) represents a second region (regions 2). Such regions are also called “bad” regions or areas.

The nature of the “bad” areas depends on the surface shapes of the optical elements 1, 2 and can be therefore engineered by designing the optical elements to have suitable surface profiles, as will be described in detail below. Importantly, the area-fraction of the aperture that is “good” or “bad” varies with the configuration of the lens and depends on the design of the individual optical elements.

A masking element (not shown) may be arranged adjacent to the pair of refractive elements such that the second regions are opaque to light transmitted through the aperture. The masking element may be fixed and therefore only exactly matched to the shape of the “bad” areas for one or a few configurations.

Alternatively, the masking element may be variable, such as for example, a pixellated LCD shutter. Alternatively, instead of a making element, the device may comprise a light absorber and the at least two refractive elements direct the light to the absorber.

In alternative devices (such as those which will be described with reference to FIG. 8), the surface profiles of the refractive optical elements may be designed such that a second (“bad”) region has a property which is distinct from that of a first (“good”) region, but which is still a useful region. For example, a device may be designed to have two or more focal lengths, one for each of the first and second regions, wherein the focal lengths are variable, albeit not independently variable.

A general class of profiles for elements forming devices in accordance with the present invention is given by the following equation:

zᵢ=f_{i;j}×g(r) for zone j of element i

where g(r) is in general an even polynomial of r, such as r² or a spherical surface. In its simplest form, the function f_{i;j} only depends on θ; in more complicated forms it can depend on both θ and r. “Zones” refer to distinct regions on a surface the element, over which the function f is continuous. These zones are typically separated by steps or kinks in the surface of the element.

FIGS. 3 to 5 schematically illustrate elements and devices in which the functions f_{i;j} are linear in θ, and have, within a single element, identical slopes. More generally, the functions f_{i;j} be linear in θ but have distinct slopes cⱼ, or they can be more complicated functions of θ. FIG. 8 schematically illustrates further devices in accordance with the present invention.

FIGS. 3A to C and FIG. 4 illustrate possible element surface profiles. The greyscale gradients in FIGS. 3A, 3C and 4 represent only the function f_{i;j} (θ,). The solid grey areas in FIGS. 3B, 3C and 4 represent the “strength” of the optical property, such as the focal length or otherwise.

FIG. 3A illustrates four exemplary distinct devices (1-4), wherein each device is made from a pair of distinct elements (each of the four devices comprises two optical elements). In each device, as the optical elements rotate relative to each other (in the direction indicated by the arrows), the configuration changes and, consequently, the sizes of the “good” and “bad” areas will change. A surface profile z of one of the two optical elements in the first device (device 1) of FIG. 3A is equal to cθr², wherein c is a constant and z, θ and r represent cylindrical coordinates. A surface profile z for a surface of the other of the two optical elements is equal to c(2π−θ)r². Accordingly, the elements have complementary surface profiles.

As explained above, ‘surface profile’ refers to a combination of the shape of the surfaces of an element and determines the total thickness (profile) of the element. It will be understood that each of the individual surfaces of the element can have a shape of the form f_{i;j}×g(r), where f and g may be different for the two surfaces of the element, such that the combination of these surface shapes determines the ‘surface profile’ of the element. Accordingly, regions are determined by both surface shapes of an element. The combined set of discontinuities (in the thickness profile) may be bigger than those of the individual surfaces, as shown in FIG. 2B. Alternatively, they could also be smaller, for example when the discontinuities coincide and have suitable step-directions such as in the case of a thickness profile of a lock washer. Hereafter, we refer to the surface profile of an element as the combination of the shapes of the surfaces of the element.

Accordingly, z is the height of a surface measured in a direction parallel to the optical axis OA, r is the distance from the optical axis OA measured perpendicular to the optical axis (wherein r has a value between 0 and R, with R being the radius of the optical aperture) and θ is the azimuthal angle in a plane perpendicular to the optical axis OA, relative to a chosen reference direction (wherein θ has a value between 0 and 2π) and c is a suitably-chosen constant. In other words, r and θ represent polar coordinates in a plane perpendicular to the optical axis OA. Surface profiles as defined above have a discontinuity running radially at azimuth θ=0.

The optical elements of devices 2, 3 and 4, respectively, have the following surface profiles:

$$\begin{matrix}z = \{ \begin{matrix}2 c θ {r}^{2} & if 0 \leq θ < π \\ 2 c ( θ - π ) {r}^{2} & if π \leq θ < 2 π\end{matrix} \\ and \\ z = \{ \begin{matrix}2 c ( π - θ ) {r}^{2} & if 0 \leq θ < π \\ 2 c ( 2 π - θ ) {r}^{2} & if π \leq θ < 2 π\end{matrix} & 2 \\ z = \{ \begin{matrix}2 c θ {r}^{2} & if 0 \leq θ < π and r \leq {r}_{0} \\ 2 c ( θ + \frac{π}{2} ) {r}^{2} & if - \frac{π}{2} \leq θ < \frac{π}{2} and r > {r}_{0} \\ 2 c ( θ - π ) {r}^{2} & if π \leq θ < 2 π and r \leq {r}_{0} \\ 2 c ( θ - \frac{π}{2} ) {r}^{2} & if π / 2 \leq θ < 3 π / 2 and r > {r}_{0}\end{matrix} \\ and \\ z = \{ \begin{matrix}2 c ( π - θ ) {r}^{2} & if 0 \leq θ < π and r \leq {r}_{0} \\ 2 c ( \frac{π}{2} - θ ) {r}^{2} & if - \frac{π}{2} \leq θ < \frac{π}{2} and r > {r}_{0} \\ 2 c ( 2 π - θ ) {r}^{2} & if π \leq θ < 2 π and r \leq {r}_{0} \\ 2 c ( \frac{3 π}{2} - θ ) {r}^{2} & if π / 2 \leq θ < 3 π / 2 and r > {r}_{0}\end{matrix} & 3 \\ z = 2 c [ ( θ - 4 π \sqrt{\frac{r}{R}} ) mod π ] {r}^{2} \\ and \\ z = 2 c [ ( 4 π \sqrt{\frac{r}{R}} - θ ) mod π ] {r}^{2} & 4\end{matrix}$$

where R is a suitably chosen normalisation radius which may or may not correspond to any physical feature of the optical element, and may be either within the optical aperture or outside it.

FIG. 3A is a representation of the individual elements for each of the four devices. Each of the elements has a surface shape of the general form

z=f(θ)×g(r)

For clarity, only f(θ) is plotted in FIG. 3A. The arrows indicate the direction of rotation that was used to generate FIG. 3B.

Accordingly, FIG. 3B represents an extended version of FIG. 3A, showing the progression of four different devices shown in four different columns (corresponding to the four devices of FIG. 3A, albeit that the elements of device 4 have a slightly different spiral shape) through 25 different configurations (one configuration per row). For these particular examples, the different grey levels correspond to different optical powers of the optical elements.

The rotations of the individual optical elements have been chosen such that, for each row, the areas of the two regions (“good” and “bad”, represented by light and dark, respectively) are the same for each of the four devices. The general shape and size of the various regions (“good” & “bad”) is determined by both surface shapes of the individual elements. In devices comprising more than two elements, the surface profiles of all elements determine the shape of the “good” and “bad” regions.

Conceptually, the simplest shape for a “bad” area of a circular aperture is a sector or wedge, while a “good” area is the complementary area of the circular aperture, as shown in device 1 of FIG. 3B. A possible modification of the shape of the “bad” areas is to divide (‘split’) the wedge into two or more smaller wedges of the same or different sizes, where the total area of the smaller wedges equals that of the initial wedge (as illustrated by devices 1 and 2 of FIG. 3B). A further possible modification of the shape of the bad areas is to displace part of the wedges around the rotation axis, as illustrated by devices 2 and 3 of FIG. 3B, wherein the outer annulus of the elements is rotated by 90 degrees (see also FIG. 3C). The displacement may be made either in discrete steps or continuously.

By combining the reshaping methods described above (splitting and displacement of the wedges), it is possible to reshape a single wedge into a two tapering spiral, for example. As illustrated by devices 1 to 4 in FIG. 3B, not only the wedge is split and the outer annulus of the elements is rotated, but the elements have been smoothly and progressively deformed from the centre outwards, adding progressively more rotation as a function of radius, but without introducing new discontinuities. In this way, the overall optical behavior of the devices may be “tuned” or optimized for particular applications. For example, rapidly wrapping spiral regions (as those of device 4 in FIG. 3B) can provide a more orientation-independent modulation transfer function (MTF).

For each of the devices shown in FIG. 3A, there is a configuration for which the entire optical aperture is “good” (i.e. the total area of the “good regions” is equal to the area of the optical aperture). It is noted, however, that other devices (as will be described below with reference to FIG. 4) do not have this property. When the optical elements are rotated relative to each other, the “bad” regions appear and grow depending on the amount by which the elements have been rotated relative to each other. If one keeps rotating the elements, one can obtain a configuration where the “bad” regions cover nearly the entire aperture, after which, once again, there is obtained a uniform optical property over the entire aperture, and identical to the starting point. This will be described in more detail in the next paragraph.

In the initial configuration of the topmost row in FIG. 3B, the entire aperture (region 1) is represented in mid-grey (apart from a horizontal black line that is an imperfection in the drawing). In further configurations shown in the rows below, one can observe region 1 to shrink and become lighter and lighter, while region 2 grows (from zero area and being black) and becomes lighter. Halfway down the columns, region 1 disappears (at the same time as having turned completely white), while region 2 covers the entire aperture and has become a uniform mid-grey. Going down in rows (configurations) further, region 1 re-appears (starting from black), grow, and becomes lighter and lighter, while region 2 shrinks and changes towards white. In the bottom configuration row, region 2 disappears (at the same time as having turned completely white), while region 1 covers the entire aperture and is a uniform mid-grey—this corresponds to the topmost configuration (initial state).

As may be seen from FIG. 3B, therefore, the area of the first region(s) divided by the total area of the aperture (i.e., the fraction of the area occupied by region 1) is a function of the surface profiles of the elements, as well as of the relative orientation of the elements. The surface profiles of the individual optical elements are necessarily related (in the sense that they need to be designed together, and cannot be chosen arbitrarily) by the requirement that the overall device has, for at least one configuration, a particular optical property.

The particular four pairs of elements shown in FIG. 3A have discontinuities in the otherwise smooth gray-scale colouring. If these discontinuities coincide when the optical elements are superimposed, the discontinuities do not show in the resulting device (FIG. 3B). If the optical elements have been rotated so that the discontinuities do not coincide when the elements are superimposed, the locations of the discontinuities will form the boundaries between the different regions, as illustrated in FIG. 3C.

In FIG. 3B each row (configuration) has the same areas for regions 1 and 2 respectively. To achieve this, the individual optical elements of device 1, have been rotated twice as much as for devices 2-4. In contrast, in FIG. 3C, the elements are rotated by the same amount. However, as seen from the bottom row of FIG. 3C, the light-coloured areas for devices 2-4 (regions 1) cover twice as much area as the light coloured areas for device 1. Additionally, the light-coloured area for device 1 is lighter than the light-coloured area for devices 2-4.

FIG. 4 shows four configurations of a single device comprising two optical elements. In contrast to the elements of devices shown in FIG. 3, the surface shapes of the individual elements shown in FIG. 4 are not complementary or similar for both elements in the device. Accordingly, modifications of any of the individual elements in a device are possible. The device of FIG. 4 comprises a pair of optical elements that never result into a single, uniform property on the entire aperture.

The first element has a surface profile z according to:

$$z = \{ \begin{matrix}c ( θ + \frac{π}{4} ) {r}^{2} & if - \frac{π}{4} \leq θ < \frac{3 π}{4} and 0 \leq r < {r}_{0} \\ c ( θ - \frac{3 π}{4} ) {r}^{2} & if \frac{3 π}{4} \leq θ < \frac{7 π}{4} and 0 \leq r < {r}_{0} \\ c θ {r}^{2} & if 0 \leq θ < π and {r}_{0} \leq r \\ c ( θ - π ) {r}^{2} & if π \leq θ < 2 π and {r}_{0} \leq r\end{matrix}$$

The second element has a surface profile z according to:

$$z = \{ \begin{matrix}c ( π - θ ) {r}^{2} & if 0 \leq θ < π \\ c ( 2 π - θ ) {r}^{2} & if π \leq θ < 2 π\end{matrix}$$

The area-fraction (a) in the first and second annuli, respectively, that is “good” is shown in FIG. 7 as a function of the angle of relative rotation α of the two elements in the device. The first annulus is located at a smaller distance from the centre of the aperture than the second annulus. It is noted that the configuration, as determined by the relative rotation α, for which the area-fraction a is maximal is not the same for the first and second annuli. Thus, the area of a second region divided by the area of a first region is dependent on the distance of the second region from the axis of rotation. This allows for reducing the size of the “bad” areas in part of the aperture for certain configurations, at the expense of increasing the size of those same “bad” areas for certain other configurations.

As described above, the “bad” areas may designed as simple, contiguous regions, may be sub-divided azimuthally into two or more sub-regions with the same or different angular width, and may be distributed throughout the aperture uniformly or non-uniformly. Additionally, the “bad” areas may be sub-divided radially into two or more disconnected regions, where these regions may or may not have the same radial width. Radial and azimuthal sub-division may also be combined, so that the number of “bad” areas at each radius need not be the same.

FIG. 5 shows an example of a device (comprising two elements) in three configurations having different subdivisions and orientations of “bad” (black) areas at different radii. The surface profile z of one surface of one of the elements of this device is given by:

$$z = \{ \begin{matrix}c ( θ - 0 ) {r}^{2} & if - \frac{π}{2} \leq θ < \frac{π}{2} and 0 \leq r < {r}_{1} \\ c ( θ - π ) {r}^{2} & if \frac{π}{2} \leq θ < \frac{3 π}{2} and 0 \leq r < {r}_{1} \\ c ( θ - π ) {r}^{2} & if 0 \leq θ < 2 π and {r}_{1} \leq r < {r}_{2} \\ c ( θ - 0 ) {r}^{2} & if - \frac{π}{3} \leq θ < \frac{π}{3} and {r}_{2} \leq r < {r}_{3} \\ c ( θ - \frac{2 π}{3} ) {r}^{2} & if \frac{π}{3} \leq θ < π and {r}_{2} \leq r < {r}_{3} \\ c ( θ - \frac{4 π}{3} ) {r}^{2} & if π \leq θ < \frac{5 π}{3} and {r}_{2} \leq r < {r}_{3} \\ c ( θ - \frac{π}{2} ) {r}^{2} & if 0 \leq θ < π and {r}_{3} \leq r \\ c ( θ - \frac{3 π}{2} ) {r}^{2} & if π \leq θ < 2 π and {r}_{3} \leq r ,\end{matrix}$$

with r₁-r₃ representing radii which define four annular regions on the aperture. The other element of the device has a complementary surface profile (wherein the constant c is replaced by −c in the above equation).
Accordingly, the area of the aperture is subdivided into four annular regions, some of which are subdivided further by azimuth θ. The annular regions are also readily apparent in the aperture of the device shown in FIG. 5.

Numbering the annular regions 1-4 from the middle outwards, the ratio (a of the “good” area to total area for each of the annular regions of FIG. 5 is as illustrated in the graph shown FIG. 6, as a function of the angle of relative rotation α of the two elements in the device.

In general, if an annular region has N “bad” regions, the ratio of “good” area to the total area depends linearly on the relative rotation α, with a slope ±N α/2π.

Accordingly, by changing the surface profiles of the elements, it is possible to sub-divide and rearrange the regions. It will be appreciated that there are many possible surface profile and re-shaping mechanisms. As described above, the areas may be subdivided into two, three, for etc sub-areas. The sub-division may results into regions that are equal or unequal, spiraling (in various ways), wiggling or otherwise shaped. The number of sub-areas into which a region may be sub-divided and the particular orientations may vary and is only limited by practical considerations during the manufacturing of the optical elements.

FIG. 8 schematically illustrates four further devices (5-8), wherein each device comprises a pair of elements in accordance with the present invention. The respective elements have surface profiles given by

$$z = \{ \begin{matrix}c ( θ - \frac{π}{2} ) {r}^{2} & if 0 \leq θ < π \\ - c ( θ - \frac{3 π}{2} ) {r}^{2} & if π \leq θ < 2 π\end{matrix} \\ and \\ z = \{ \begin{matrix}- c ( θ - \frac{π}{2} ) {r}^{2} & if 0 \leq θ < π \\ c ( θ - \frac{3 π}{2} ) {r}^{2} & if π \leq θ < 2 π\end{matrix}$$

The lines visible in the bottom row separate regions (sectors) with constant optical property from those with grayscale gradients. For example, if the optical property is power, the “gradient” sections would not represent optical power but some form of aberration.

1. An optical device comprising at least two refractive optical elements arranged along an optical axis of the device, each refractive optical element having a surface profile,
wherein the device has an optical aperture common to the at least two refractive optical elements and wherein at least one refractive optical element is arranged to rotate relative to another refractive optical element around a rotation axis which intersects the aperture of the device,
wherein the device has a plurality of configurations, each configuration having a predetermined optical property over at least a first region of the aperture; the configurations being selected by rotating the at least one refractive optical element arranged to rotate; and
wherein the total area of the first regions divided by the total area of the aperture is a function of the surface profiles of the at least two refractive optical elements.

2. An optical device according to claim 1, wherein the predetermined optical property is a focal length.

3. An optical device according to claim 1, wherein a configuration has an optical property discrete from the predetermined optical property over at least a second region of the aperture.

4. An optical device according to claim 3, wherein the optical property discrete from the predetermined optical property is a focal length.

5. An optical device according to claim 3, wherein the device further comprises a masking element arranged adjacent to the at least two refractive optical elements such that the second regions are opaque to light transmitted, in use, through the aperture.

6. An optical device according to claim 5, wherein the masking element is fixed.

7. An optical device according to claim 5, wherein the masking element is variable.

8. An optical device according to claim 3, further comprising a light absorber, the at least two refractive optical elements being arranged such that light transmitted, in use, through the second regions of the aperture is directed to the light absorber.

9. An optical device according to claim 1, wherein the rotation axis is parallel to the optical axis.

10. An optical device according to claim 1, wherein the rotation axis is the optical axis.

11. An optical device according to claim 1, wherein at least one refractive optical element is adapted to continuously rotate to continuously select a configuration.

12. An optical device according to claim 1, wherein the optical aperture is a circular aperture.

13. An optical device according to claim 1, wherein the surface profile z of at least one refractive optical element is defined by z=cθr2, wherein c is a constant and z, θ and r represent cylindrical coordinates.

14. An optical device according to claim 1, wherein the surface profile z of at least one refractive optical element is defined by:
$$z = \{ \begin{matrix}2 c θ {r}^{2} & if 0 \leq θ < π \\ 2 c ( θ - π ) {r}^{2} & if π \leq θ < 2 π\end{matrix}$$
wherein c is a constant and z, θ and r represent cylindrical coordinates.

15. An optical device according to claim 1, wherein the surface profile z of at least one refractive optical element is defined by
$$z = \{ \begin{matrix}2 c θ {r}^{2} & if 0 \leq θ < π and r \leq {r}_{0} \\ 2 c ( θ + \frac{π}{2} ) {r}^{2} & if - \frac{π}{2} \leq θ < \frac{π}{2} and r > {r}_{0} \\ 2 c ( θ - π ) {r}^{2} & if π \leq θ < 2 π and r \leq {r}_{0} \\ 2 c ( θ - \frac{π}{2} ) {r}^{2} & if π / 2 \leq θ < 3 π / 2 and r > {r}_{0}\end{matrix}$$
wherein c is a constant and z, θ and r represent cylindrical coordinates.

16. An optical device according to claim 1, wherein the surface profile z of at least one refractive optical element is defined by:
$$z = 2 c [ ( θ - 4 π \sqrt{\frac{r}{R}} ) mod r ] {r}^{2}$$
wherein c is a constant, z, θ and r represent cylindrical coordinates and R is a normalisation radius.

17. An optical device according to claim 16, wherein, in one configuration of the device, the area of a second region divided by the area of a first region is a function of the distance of the second region from the axis of rotation.

18. An optical device according to claim 1, comprising two refractive optical elements with complementary surface profiles.

19. A method of selecting a configuration from a plurality of configurations of an optical device, the method comprising the steps of:
directing light through an optical aperture common to at least two refractive optical elements arranged along an optical axis, wherein each refractive optical element has a surface profile, and
rotating at least one refractive optical element relative to another refractive optical element around a rotation axis which intersects the aperture,
wherein each configuration has a predetermined optical property over at least a first region of the aperture; and
wherein the total area of the first regions divided by the total area of the aperture is a function of the surface profiles of the refractive optical elements.

20. A method according to claim 19, wherein the predetermined optical property is a focal length.

21. A method according to claim 20, wherein a configuration has an optical property discrete from the predetermined optical property over at least a second region of the aperture.

22. A method according to claim 21, wherein the optical property discrete from the predetermined optical property is a focal length.

23. A method according to claim 21, the method further comprising the step of masking the at least two refractive optical elements such that the second regions are opaque to the light transmitted through the aperture.

24. A method according to claim 21, further comprising the step of directing the light transmitted through the second regions of the aperture to a light absorber.

25. A method according to claim 19, wherein the rotation axis is parallel to the optical axis.

26. A method according to claim 19, wherein the rotation axis is the optical axis.

27. A method according to claim 19, wherein rotating the at least one refractive optical element comprises continuously rotating at least one refractive optical element.

28. A method according to claim 19, wherein the optical aperture is a circular aperture.

29. A method according to claim 19, wherein the surface profile z of at least one refractive optical element is defined by z=cθr², wherein c is a constant and z, θ and r represent cylindrical coordinates.

30. A method according to claim 19, wherein the surface profile z of at least one refractive optical element is defined by:
$$z = \{ \begin{matrix}2 c θ {r}^{2} & if 0 \leq θ < π \\ 2 c ( θ - π ) {r}^{2} & if π \leq θ < 2 π\end{matrix}$$
wherein c is a constant and z, θ and r represent cylindrical coordinates.

31. A method according to claim 19, wherein the surface profile z of at least one refractive optical element is defined by:
$$z = \{ \begin{matrix}2 c θ {r}^{2} & if 0 \leq θ < π and r \leq {r}_{0} \\ 2 c ( θ + \frac{π}{2} ) {r}^{2} & if - \frac{π}{2} \leq θ < \frac{π}{2} and r > {r}_{0} \\ 2 c ( θ - π ) {r}^{2} & if π \leq θ < 2 π and r \leq {r}_{0} \\ 2 c ( θ - \frac{π}{2} ) {r}^{2} & if π / 2 \leq θ < 3 π / 2 and r > {r}_{0}\end{matrix}$$
wherein c is a constant and z, θ and r represent cylindrical coordinates.

32. A method according claim 19, wherein the surface profile z of at least one refractive optical element is defined by:
$$z = 2 c [ ( θ - 4 π \sqrt{\frac{r}{R}} ) mod π ] {r}^{2}$$
wherein c is a constant, z, θ and r represent cylindrical coordinates and R is a normalisation radius.

33. A method according to claim 21, wherein, in one configuration of the device, the area of a second region divided by the area of a first region is a function of the distance of the second region from the axis of rotation.

34. A method according to claim 19, wherein two refractive optical elements have complementary surface profiles.
